(19) United States
(12) Patent Application Publication
(10) Pub. No.: US 2026/0330313 A1
(43) Pub. Date: Oct. 22, 2026

(54) OPTIMIZING COMPETING COMPUTER MODEL ASPECT PRIORITIES

(71) Applicant: THE TORONTO-DOMINION BANK, TORONTO (CA)

(72) Inventor: Jesse Cole Cresswell, TORONTO (CA)

(21) Appl. No.: 19/562,197

(22) Filed: Mar. 10, 2026

Related U.S. Application Data
(60) Provisional application No. 63/790,543, filed on Apr. 17, 2025.

(51) Int. Cl. G06N 20/00

(52) U.S. Cl. CPC G06N 20/00

(57) ABSTRACT

To incorporate multiple aspects of trustworthy AI (TAI) into model development processes, the inclusion of TAI aspects to model development is incrementally performed to evaluate the effects of different TAI aspects on one another. To do so, the TAI aspects are prioritized for a given model, like a classifier, large language model or agentic model, to determine which aspects have which relative importance for the model. Modifications expected to improve a particular TAI aspect are evaluated for the model architecture by evaluating the model before and after the modification is applied. As the modifications are sequentially evaluated, metrics for the TAI aspects, particularly higher-priority aspects relative to the particular TAI aspect of the evaluated modification, are determined for the model architecture. The effect of the modification on other TAI aspects can then be quantified and used to determine whether to accept or reject model architecture modifications.

### CROSS-REFERENCE TO RELATED APPLICATION

This application claims the benefit of U.S. Provisional Application No. 63/790,543, filed on Apr. 17, 2025, the contents of which is hereby incorporated by reference in its entirety.

### BACKGROUND

This disclosure relates generally to incorporating additional aspects to computer model frameworks and more particularly to optimizing multiple trustworthiness aspects added to computer model frameworks.

Artificial intelligence (AI) systems have become widespread for automated decision making across industries, and as productivity aids for consumers. Industries such as banking and insurance increasingly rely on predictive AI models that directly impact customers, while the healthcare sector explores AI-driven advancements in patient care. Increased scrutiny by regulators and concerns around the trustworthiness of these systems call for a measurable approach to AI development with considerations beyond raw performance. In response, the field of Trustworthy AI (TAI) has blossomed, with the general goal of aligning AI to human values. Chief among the tenets of TAI are additional aspects of fairness, privacy, robustness, explainability, and uncertainty quantification. Each of these is a valuable aim for improving model acceptance in real implementations, but all of which must be harmonized to promote deep trust in model development and usage.

These aspects are typically studied in isolation in machine learning (ML). However, isolated study fails to account for the complex interactions between TAI aspects. Layering multiple methodologies designed for individual aspects tends to produce unforeseen consequences, ultimately undermining trust rather than reinforcing it. The interactions between these aspects and effective integration of multiple of these aspects while aligning with real-world priorities has not been effectively studied or developed.

### SUMMARY

Computer models may be trained and implemented with various additional processes designed to enhance various additional aspects beyond model accuracy that enable real-world trustworthiness of the model. For example, the models may aim to incorporate Trustworthy AI aspects (generally, “aspects”) that enhance fairness, privacy, robustness, explainability, and uncertainty quantification. However, efforts to enhance one aspect often introduce unintended trade-offs that negatively impact others, making it challenging to improve all aspects simultaneously.

To automatically develop effective AI systems that account for the differing and sometime unpredictable effects that these aspects have on one another, the different aspects are prioritized such that the relative importance for the particular application is defined by a ranking of the aspects reflecting the relative priority of each aspect. The ranking is used to determine a sequence in which modifications for the respective aspects are applied to the model framework. For each modification, a model baseline is determined that defines the condition of the model before applying the modification, which may include application of modifications of other aspects. The model baseline is evaluated to determine a set of baseline metrics measuring the model baseline with respect to the various aspects. Next, the model with the modification applied is evaluated with the same metrics to determine modified metrics. This enables an iterative, step-wise comparison of the metrics before and after the modification for a particular is used with a model. Then, modifications can be accepted that do not excessively impact the metrics (particularly the metrics for higher-priority aspects than the aspect associated with the modification).

As the modifications are applied to the model in the sequence, the highest-priority aspects are addressed by the first-applied modifications, such that as subsequent modifications are applied and evaluated, the subsequent modifications can be reverted when they excessively affect higher-priority aspects. As a result, this approach can provide an “intersectional” analysis of combining these aspects, enabling measurement and analysis of the ways in which modifications designed to improve individual aspects impact one another when they are combined together. Further, prioritization of the aspects can resolve selection of the modifications when the interact negatively with one another, enabling selection of an overall set of modifications that advance metrics for the highest-priority aspects without undue penalty from counterproductive modifications. This provides a more holistic view of “Trustworthy” AI that accounts for effects across many aspects at once.

### BRIEF DESCRIPTION OF THE DRAWINGS

FIG. 1 illustrates an example model training system that implements modifications for trustworthy AI (TAI) aspects, according to one or more embodiments.

FIGS. 2A-C show example data flows of modifications for TAI aspects, according to one or more embodiments.

FIG. 3 shows an example flow chart for incorporating multiple TAI aspects to a model, according to one or more embodiments.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

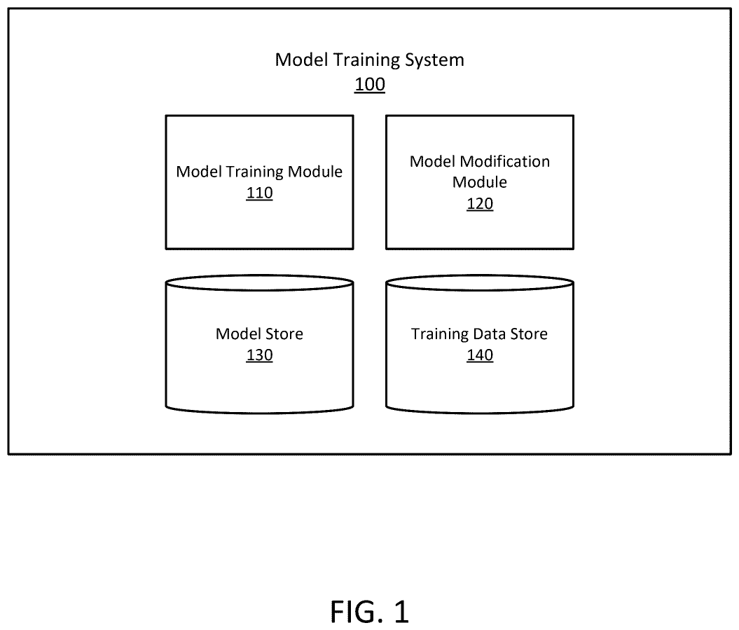

FIG. 1 illustrates an example model training system 100 that implements modifications for trustworthy AI (TAI) aspects, according to one or more embodiments. In general, the model training system 100 trains computer models that may be stored in model store 130 using a set of training data in training data store 140. The models may be trained with a model training module 110 that trains the models according to an applicable model architecture and training configuration. In addition to training the model with respect to the model's target objective (e.g., to minimize an error of model-predicted outputs relative to labeled outputs), a model modification module 120 considers and applies modifications to the model architecture to incorporate various aspects of trustworthy AI. For example, various TAI aspects may include considerations of fairness (e.g., inter-group differences), privacy, explainability, uncertainty quantification, and robustness.

Generally, the TAI aspects may thus relate to considerations for responsible development and application of computer models beyond whether the model is “accurate” with respect to its training set. For example, a model that has high accuracy but is trained or can be exploited in a way that can reveal sensitive private information may not be implementable in practice. Similarly, in many applications, models that lack explainability or explain model outputs in seemingly arbitrary ways may lack the necessary confidence for implementation in many applications. Even when these models perform well on test data (i.e., the accuracy is high), the inability to effectively explain the model determinations may reduce useability and confidence that the model can be effectively applied to different (i.e., subsequent) data sets. Techniques for modifying a model architecture are often designed for improving a single TAI aspect.

As discussed further below, the model modification module 120 implements modifications for multiple TAI aspects using a ranking or other prioritization of the TAI aspects of interest for particular model. The model modification module 120 uses the ranking to apply and evaluate TAI aspects in sequence and to measure the effects of the modifications on metrics relevant to the TAI aspects. As such, in each iteration, the model modification module 120 may evaluate a modification intended to improve a particular TAI aspect and determine whether to accept or reject that modification based on the resulting metrics for the aspects of interest. This enables the model modification module 120 to sequentially evaluate modifications to account for TAI aspects of interest while preventing modifications for comparatively less-important TAI aspects to excessively affect more-important TAI aspects (or the model's overall quality). The various TAI aspects and operation of the model modification module 120 in implementing modifications to the model architecture are discussed in further detail below.

Various configurations may apply to models configured for different types of data and different purposes. In general, the example model architectures discussed below relate to a classification model implementing a function F through a plurality of model layers having configurable parameters θ parameterized by θ, which maps a feature space X to a discrete set of labels Y, such that F_{θ}:X→Y. Generally, capital letters (e.g. X and Y) are used herein to denote random variables in the respective data space, while lower case letters (e.g., x∈X and y∈Y) indicates particular data points (e.g., data instances or data samples). Generally, the model training module 110 trains the parameters θ of the model (and hence learn the overall function represented by the model Fe) to minimize a loss function L over its training set Dₜᵣₐᵢₙ. In the classification context, outputs of the model may be generated by a Softmax layer applied to output logits associated with each class, such that Softmax outputs are denoted as F_{θ}:X→[0, 1]m over m classes, such that the predicted class of the model is typically designated as the class i having the highest value after applying the Softmax layer: F_{θ}(x)=argmax_{i∈Y}f_{θ}(x)ᵢ.

The models developed by the model training system 100 (and may be stored in the model store 130) may include various types of model architectures and domains that are suitable for applying trustworthy AI aspects and related modifications. The data domains and model architectures may include different types of data domains, such as image, text, audio, tabular data, and so forth. The related model architectures may thus include various types of models having a plurality of configurable parameters that are learned during the training process by the model training module 110. The model architectures may include various layers that perform different operations on the respective data inputs and intermediate data representations in the model. The model architectures may include various layers that transform, reduce, expand, and otherwise modify the input data sample to generate the model output. The model layers vary according to the data domain and particular implementation and may include fully-connected layers, convolutional layers, activation layers, recurrent layers, and so forth. In addition, the overall model architecture may include various pre-processing, post-processing, and other steps for processing data inputs for a suitable output of the model.

Although the discussion below generally relates to classification models, similar principles may be applied to other types of models, such as generative models, language models, agentic models, and so forth, that may implement modifications for incorporating trustworthy AI aspects. For example, generative models may include TAI aspects related to preventing the generation of undesirable content (e.g., with considerations of legal, moral, or ethical concerns) or excess similarity to copywritten works.

Generally, each TAI aspect may be associated with one or more modifications to the model architecture that is intended to improve or implement the associated TAI aspect. Model modifications may include modifications to pre-training, feature selection, feature normalization, model architecture, parameter training, interactions with other training systems, loss/objective function, training/parameter update algorithm, validation/certification, modifications to inference steps, and so forth. For example, uncertainty quantification for classification models may use post-model outputs to generate a coverage set having a quantified level of confidence that the coverage set contains the correct classification. Similarly, modifications for incorporating privacy concerns may modify the training process (i.e., updating model parameters with differential-privacy stochastic gradient descent), and modifications for fairness may require including (or excluding) sensitive information in data collection and model application. As such, the overall model architecture that may be modified to address TAI aspects may include the pipeline of data collection for the training data through to how the generated model outputs are processed to affect subsequent actions (e.g., providing processed model outputs for manual review).

In addition, each TAI aspect may also be associated with one or more metrics that measure the model architecture performance with respect to that aspect. The metrics may include measuring different aspects of the model architecture and can vary significantly depending on the particular TAI aspect. For example, metrics related to privacy may measure the extent to which private data about a data point can be derived from various aspects of the model (e.g., during training or model inference), while metrics related to uncertainty quantification may be measured based on the size of a coverage set for a particular data point or group of data points. Various metrics and modifications are discussed below.

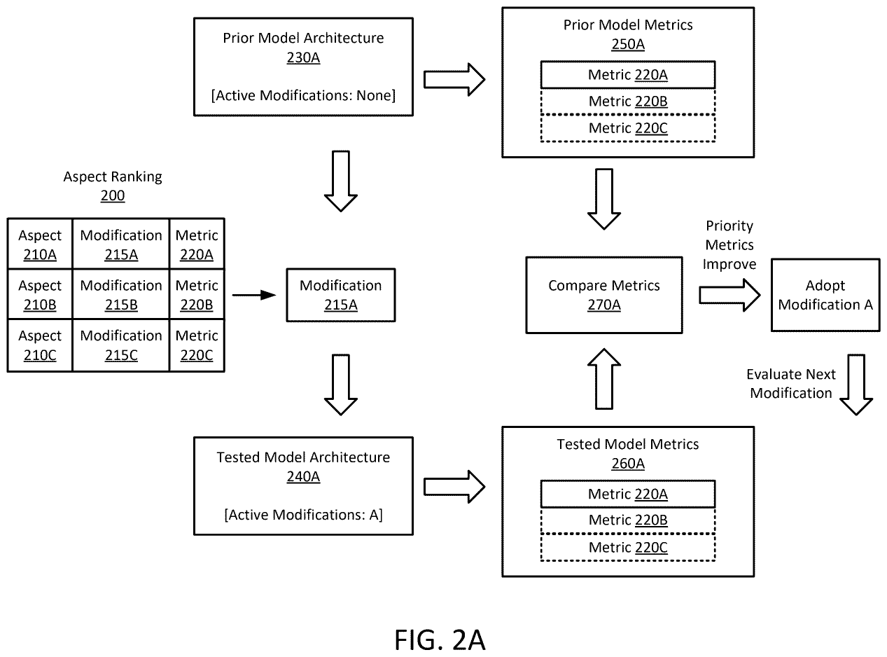

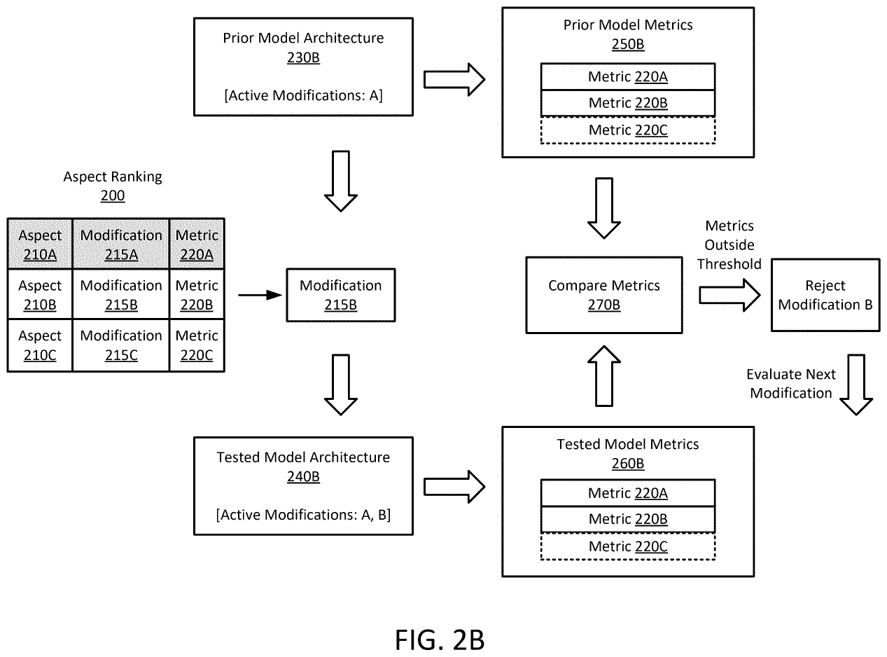

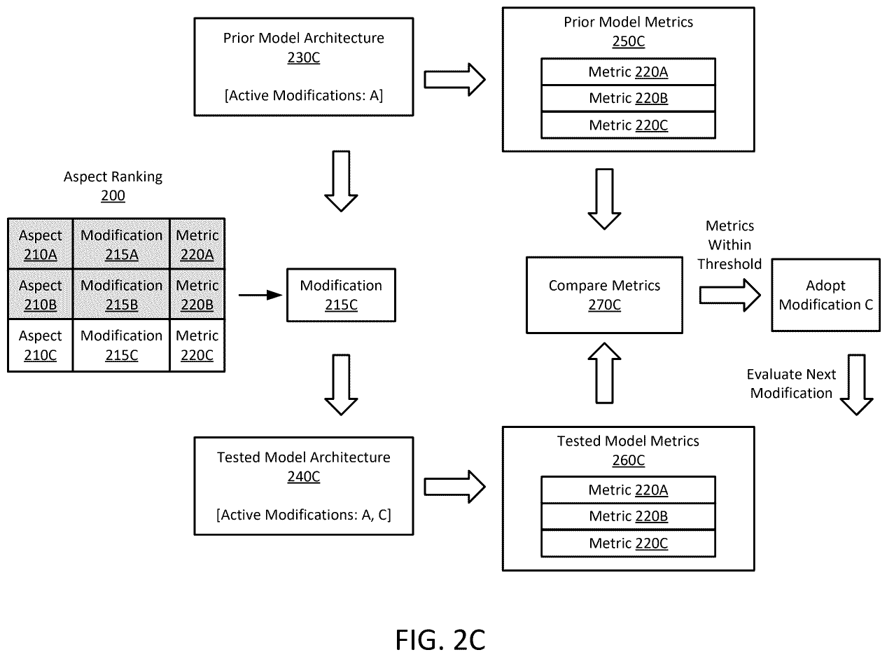

As the model modification module 120 implements and evaluates various modifications for the model, the model training module 110 may train or re-train the model parameters based on the relevant training data in training data store 140. The evaluation of modifications for TAI aspects is discussed further below with respect to FIGS. 2A-C. First, a brief discussion of example TAI aspects and associated metrics, modifications, and potential interactions between them.

Finally, FIG. 1 shows certain modules for training and evaluating models for incorporating TAI aspects as a part of model training system 100. In various embodiments, these components are distributed to additional systems and different functionalities may be provided by different computing devices. In addition, the model training system 100 may provide trained models to additional systems for applying the trained models to additional data points.

### Metrics and Modifications for Trustworthy AI (TAI) Aspects

This section discusses five TAI aspects, whose potential interactions are discussed in the following section. These discussions below focus on a limited set of TAI aspects to represent the significance of these various additional aspects on practical model development and implementation and potential interactions between them. As such, these TAI aspects are examples and are not exhaustive examples of the aspects that may be included in various embodiments. Each of these aspects may also be associated with one or more metrics for quantifying and measuring the aspect along with modifications to model training, architectures, and/or other processes designed to improve the associated aspect. As such, each TAI aspect may be associated with at least one modification (i.e., to the training, architecture, etc. for furthering that TAI aspect) and one or more metrics for measuring the aspect.

### Fairness.

Fairness is a TAI aspect relating to treating diverse populations equally or equitably. Since fairness is a nuanced and highly contextual topic, it generally cannot be specified as a single set of guidelines to follow in all cases. Instead, particular implementations use various fairness definitions and related modifications for each circumstance.

As one example, fairness may consider situations where the data is partitioned into groups based on an attribute. The fairness objective aims to create a model that treats all groups fairly by equalizing its prediction behavior. Exactly how this is defined varies from one application to the next.

As one example, fairness may be evaluated with respect to procedural and/or substantive fairness. Procedural fairness emphasizes treating all individuals (i.e., data inputs) equally from a procedural basis. A model which does not have access to group identifiers cannot treat individuals differently based on that information, leading to fairness through unawareness. Fairness concerns can be raised when “disparate treatment” results from procedurally unfair processes. Meanwhile, substantive fairness may consider fairness from a perspective related to “equity” and encourage comparable outcomes across groups, even if there may be some process that treats individuals differently to achieve these comparable outcomes. In this paradigm, if individuals do not receive the same beneficial outcomes from a model, there is a disparate impact.

Both procedural and substantive fairness are commonly used concepts as “disparate treatment” and “disparate impact” in legal and regulatory frameworks. Disparate impact can be measured in terms of the target outcome of the model, for instance through accuracy disparity across groups:

$${Δ}_{acc} = {max}_{a , b ∈ A} [ acc ( {F}_{θ} , {D}_{a} ) = acc ( {F}_{θ} , {D}_{b} ) ] \qquad Equation 1$$

where Dₐ denotes the subset of D belonging to group a and F_{θ} is the model outcome evaluated with model parameters θ.

Minimizing the difference in accuracy between groups (Δ_{acc}) is one example of a fairness metric (i.e., as a measurable goal), and can be pursued at several stages including pre-processing (e.g. balancing data across groups before training), in-processing (e.g. adding fairness regularization terms to the loss L), or post-processing (e.g. using model scores differently across groups when making decisions). These fairness interventions are examples of modifications that intentionally treat groups differently so that outcomes will be more similar (i.e., to improve the defined fairness metric).

### Privacy.

Privacy is another TAI aspect that has become crucial as systems increasingly rely on sensitive data for training and include sensitive information that should not be revealed to any unauthorized parties. The use of personal information, such as health records, financial transactions, and social media activity, has led to growing concerns about privacy breaches, unauthorized data access, and the risk of re-identification.

In the context of measuring privacy effects (e.g., as a metric), privacy concerns are usually demonstrated adversarially, where an attack is employed to extract as much private information as possible from the model itself, or its outputs. The standard example is a membership inference attack (MIA) in which the adversary tries to determine if a test data point was included in the domain training set. MIAs demonstrate when a system can fail to preserve privacy, but an unsuccessful MIA does not indicate the system is safe; there could always exist a stronger adversarial attack that would succeed. Hence, modifications for privacy aspects are preferably applied with frameworks that provide statistical guarantees on privacy protection.

Differential privacy (DP) is the primary framework for quantifying how much private information could be exposed by an ML model. Formally, M is a probabilistic function acting on data sets D where M is (ϵ, δ)-differentially private if: for all subsets of possible outputs S⊆Range (M) and for all pairs of data sets D and D′ that differ by the addition or removal of one element:

Pr[M(D)∈S]≤exp(ϵ)Pr[M(D′)∈S]+δ Equation 2

This inequality guarantees that the function M cannot strongly depend on any one data point, and hence the amount of information that can be extracted about any data point is bounded. Strong DP guarantees (i.e. ϵ and δ both close to 0) have been empirically shown to be effective defenses against MIAs and other privacy attacks. Importantly, no amount of post-processing on the outputs on M can weaken its guarantee.

DP is typically achieved in computer models with a modification to the training approach, particularly with differential-privacy stochastic gradient descent (DPSGD), a stochastic gradient descent method that satisfies Eq. (2). When modifying model parameters during training, DPSGD first computes per-sample gradients and clips them, then aggregates them before adding noise. For samples xᵢ, yᵢ in a batch B, and per-sample gradients gᵢ=∇θL(θₜ; xᵢ, yᵢ) the DPSGD gradient update is

$${θ}_{t + 1} = {θ}_{t} - λ [ \frac{1}{\vert B \vert} {\sum }_{i ∈ B} {clip}_{c} ( {g}_{i} ) + \frac{σ C}{\vert B \vert} ξ ] \qquad Equation 3$$

where λ is the learning rate, Cis the clipping bound, σ is the noise level, ξ~N(0, I) is Gaussian noise, Ot are the model parameters for an evaluated training batch and θₜ₊₁ are the model parameters after the update. As training with DPSGD progresses, more privacy budget is consumed (ϵ and δ increase), which can be accounted for and measured numerically.

### Robustness.

Robustness broadly refers to the ability of a model to maintain its performance and reliability under a variety of conditions. Since stable performance is desired even in unforeseen situations, robustness is often tested and measured adversarially. An attacker will actively try to produce unintended model behavior by perturbing the input of a model, often in ways that are imperceptible or seem insignificant to humans. Adversarial examples can be created through optimization by maximizing the model's loss on the correct answer rather than minimizing:

$${x}^{†} ( θ , {x}_{i} , {y}_{i} ) = arg {max}_{x ∈ B ( {x}_{i} , ε )} L ( θ ; x , {y}_{i} ) \qquad Equation 4$$

where x^{†} is constrained to be “close” to xᵢ, for instance within a ball B (xᵢ, ε) of radius ε around xᵢ. As one modification to reduce the efficacy of attacks, the model may be exposed to adversarially perturbed inputs during training, such that the training data includes the perturbed training data samples or a loss function that considers the perturbed data sample, such as:

$${θ}_{t + 1} = {θ}_{t} - λ \frac{1}{\vert B \vert} {\sum }_{i ∈ B} {∇}_{θ} L ( {θ}_{t} ; {x}^{†} ( {θ}_{t} , {x}_{i} , {y}_{i} ) , {y}_{i} ) \qquad Equation 5$$

### Explainability.

Explainability enables researchers and practitioners to understand, validate, and trust decisions made by complex models, and gives the ability to audit those decisions retroactively. When humans manually accept or reject a model's prediction, explanations help them understand the reasoning behind the decision and compare it to their own expertise.

Some ML models are inherently more interpretable, such as shallow decision trees and linear models, but deep neural networks are not. Methods to explain complex models may focus on global explanations, providing an overarching understanding of model behavior, or local explanations, which shed light on individual predictions. Local explanation approaches may apply to many different features types and may be based on explanations related to particular input features of the data sample. These methods interpret behavior by analyzing the importance of input features for a given prediction, regardless of the underlying model architecture. For an input x, in addition to the model's output F_{θ}(x), a local explainability method also provides some form of feature importance E_{θ}(x) that provides a quantification of how important each element of x is for predicting F_{θ}(x).

As one example, Local Interpretable Model-agnostic Explanations (LIME) aims to provide local explanations that preserve local fidelity—that the explanations correspond to the model's actual behavior in the vicinity of data sample x. LIME's explanations take the form of a model, one that is inherently more interpretable than F_{θ}(x), namely a sparse linear model that locally approximates F_{θ} at x. The weights of the linear model are returned as E_{θ}(x) and communicate how important each corresponding feature is.

In addition, different approaches for explainability may explain the model in different ways or with different detail or accuracy, along with different trade-offs, for example, requiring analysis of different numbers of data samples or different intervention in model analysis (e.g., additional different amounts of additional processing to model activity).

### Uncertainty Quantification.

Typical computer models output a point prediction (e.g. a single label for classification) and are not designed to quantify confidence in those predictions. For example, in classification problems, Softmax outputs f_{θ}(x) on class logits may be unreliable because of miscalibration. Models that quantify their uncertainty are more trustworthy, as the user can judge when to ignore the model in favor of alternatives. While there are several major approaches to uncertainty quantification, we focus on one increasingly popular method, conformal prediction (CP). The idea of CP is to output sets of predictions (e.g. several class labels) where larger sets indicate greater model uncertainty. CP takes a heuristic notion of uncertainty, like f_{θ}(x), and calibrates it using a held-out data set D_{cal} to give statistically grounded uncertainty quantification. CP defines a conformal score function s:X×Y→R, where larger values indicate worse agreement between f_{θ}(x) and y. After computing s on the n_{cal} calibration data points, a ┌(n_{cal}+1)(1−α)┐ n quantile q of the conformal scores is determined, using a free parameter α∈(0, 1). For a new data point xₜₑₛₜ, prediction sets C_{q} are generated by including all output values for which the conformal score is below the threshold q,

C_{q}(xₜₑₛₜ)={y∈Y|s(xₜₑₛₜ,y)<q} Equation 6

Notably, CP provides a coverage guarantee over the true label yₜₑₛₜ,

[symbol]

[yₜₑₛₜ∈C_{q}(xₜₑₛₜ)]≥1−α Equation 7

as long as xₜₑₛₜ is exchangeable with the calibration data drawn from P. Hence, the user can specify a maximum error rate, α, ensuring that the sets generated during testing will exclude the ground truth no more often than α. For equal coverage levels, the usefulness of prediction sets is judged by their size, with smaller average set sizes E|C_{q}| indicating more confident predictions.

As such, quantifying “certainty” in models may be performed with various modifications to the model and its application and can be provided with different levels of confidence (e.g., a coverage guarantee) but can require modifications to the training data holdout and post-model processing.

### Further Aspects.

There are many additional aspects one may strive to achieve when building trustworthy AI systems that may also be included in various embodiments. Safety may mean ensuring that AI systems cannot cause harm to users, subjects, society, or the environment, which may differ from the express training objective of the model. Considerations of “alignment” focus on ensuring that the objectives and behaviors of an AI agent are consistent with human values and societal goals. Diversity entails incorporating diverse perspectives, identities, and contexts in the design, development, and deployment of AI systems. Reproducibility allows outputs from AI to be replicated on demand, which is important for the advancement of AI science, but just as importantly, allows real-world deployments of AI to be audited. Accountability clearly assigns responsibility for AI decisions and their outcomes, providing legal recourse when AI systems cause harm. Human agency means ensuring that AI systems empower individuals to make informed decisions, rather than overriding human autonomy. Additional aspects may include accessibility, adaptability, and others that are omitted here for brevity but may be included in various embodiments with respective metrics and modifications.

### Potential Interactions Between Aspects

Various ways of improving one aspect may, necessarily or as an incident of the related modification, negatively affect another aspect. Various interactions are discussed below as examples. To demonstrate that negative interactions between the modifications for these aspects are common and typically not the exception, various pairwise combinations of Fairness (F), Privacy (P), Robustness (R), Explainability (E), and Uncertainty Quantification (UQ) are discussed below. While there are also examples of positive interactions between TAI aspects, the discussion below focuses on negative interactions to demonstrate the potential harms of failing to consider unique effects of combining multiple aspects when constructing combinations of model modifications.

Fairness Can Affect Privacy: At the most basic level, evaluating or correcting the fairness of an ML model with for a group usually necessitates collecting information on the related group identifier. These identifiers, like age, gender, or race, are often sensitive personal information-exactly the type of information that should be afforded privacy. Collecting, storing, and using this information for fairness purposes exposes individuals to greater risk of conventional data leaks or hacks.

Beyond conventional privacy leaks, trained models can leak private information through membership inference attacks (MIAs) which exploit the differences in model behavior between populations. Fairness interventions during training can reduce the differences between populations, and hence better protect against standard MIAs. However, such techniques can also unexpectedly increase vulnerability to specialized MIAs that are also group-aware. Generally, fairness-aware ML algorithms are more likely to memorize from underrepresented groups, improving model accuracy, but weakening privacy.

Privacy Can Affect Fairness: Some individuals or groups in the data can be more vulnerable to privacy attacks than others. When vulnerability is unequal, applying privacy-enhancing techniques can improve the privacy of some groups more than others, an example of Disparate Impact. Protecting a vulnerable group by removing it from the training set is counterproductive, as the vulnerability merely shifts to a different group.

While Differential Privacy Stochastic Gradient Descent (DPSGD) is a common method for achieving privacy guarantees during model training, DPSGD can negatively affect fairness (e.g., causing Disparate Impact) by increasing accuracy disparity as compared to ordinary Stochastic Gradient Descent (SGD). For example, if a group is underrepresented, or is otherwise more difficult to correctly predict on, DPSGD may increase Disparate Impact. In ordinary SGD, data points from this group would have higher loss, and hence larger gradients, which would increase their relative influence on the optimization. In DPSGD, large gradients with a high magnitude (over a threshold) are clipped, making them relatively less influential on the optimization process. This uneven clipping (some data points are clipped while others are not) can introduce bias into the gradients and be a source of Disparate Impact.

Fairness Can Affect Robustness: When groups in the data set are underrepresented, fairness interventions to reduce model bias can increase the relative influence of those groups. Unfortunately, this increased influence can make the very same groups more susceptible to adversarial attacks. Similarly, fairness interventions can reduce the average distance from training samples to the decision boundary, which makes them more vulnerable to adversarial examples.

Robustness Can Affect Fairness: The main method to improve adversarial robustness, namely adversarial training, adds perturbed versions x^{†} of inputs x to training batches. The side-effects of adversarial training include decreased overall accuracy on unperturbed samples, but more importantly for fairness, larger disparities in class-wise performance across classes. This robustness bias in class-wise performance has been attributed to properties of the data distribution like feature distributions across groups, differences in the intrinsic difficulty of classes, and biased representations learned during pretraining.

Fairness Can Affect Explainability: Fairness interventions can inadvertently alter the relative importance of features in explanations. Pre-processing modifies the training data through re-balancing or other transformations and can thus obscure the true relationships between features and outcomes, making it challenging to interpret model behavior accurately. For instance, if less-frequent groups are oversampled to increase their representation, an explainability method may correspondingly overemphasize the importance of features associated to that group. The same issue can occur from in-processing as the influence of various features is altered by, for example, fairness constraints added to the loss. Meanwhile, post-processing methods that modify predictions without altering the underlying model can create a disconnect between the model's internal decision-making process and the actual predictions that are used after the post-processing.

Explainability Can Affect Fairness: Explanations introduce another potential source of bias in modeling. Even if a model's predictions are considered fair, the fidelity of explanations may be inconsistent across groups—that is, for some groups, the features identified as important in the explanation may not truly reflect the features driving the model's predictions. This fidelity disparity can lead to the model's predictions being trusted more for some groups than others, such that the benefits of the model are not evenly experienced across groups. In some cases, post hoc explanation methods used on neural networks commonly have disparate fidelity across groups.

Alternatively, explanations may hide biases in an unfair model. For instance, explanations may fail to accurately represent that a model is relying on sensitive attributes, covering up active discrimination.

### Tension Between Fairness and Uncertainty Quantification

In conformal prediction (used for Uncertainty Quantification), the coverage guarantee in Eq. (7) holds marginally over the entire distribution P. Hence, it is possible that some groups within the distribution have lower coverage than others, leading to tension between fairness and UQ. One approach to resolving this tension includes uncertainty quantification that is calibrated for group membership, such as group-wise conditional coverage with respect to pre-defined groups A,

[symbol]

[y∈C(x)|A=a]≥1−α, ∀a∈A Equation 8

Group-wise conditional coverage can be obtained by partitioning the calibration data into groups and performing CP on each group's data, giving distinct thresholds qₐ to each group a. At test time, sets are generated using Eq. (6) with the appropriate group threshold qₐ.

Fairness Can Affect Uncertainty Quantification: Alternatively, fairness may be better served by providing equal levels of coverage across groups A as “Equalized Coverage.” Equalized Coverage may be expressed as:

$${Δ}_{Cov} = {max}_{a , b ∈ A} ( \text{?} [ y ∈ C ( x ) \vert A = a ] - \text{?} [ y ∈ C ( x ) \vert A - b ] ) \approx 0 \qquad Equation 9$$

Marginal coverage (CP without group-based thresholds) gives no guarantee that Equation 9 will hold, but group-wise conditional coverage does. However, Equalized Coverage negatively impacts the usefulness of prediction sets for uncertainty quantification by increasing their average size for more difficult groups, meaning the model expresses a greater level of uncertainty than it would using marginal CP. Additionally, partitioning the calibration set by group means each individual calibration is done with fewer data points. This increases variance, and the probability that the desired coverage level 1-a is breached in practice.

Uncertainty Quantification Can Affect Fairness: Classes Y in a decision problem often represent mutually exclusive actions, hence a prediction set output from conformal prediction cannot be acted on by itself. Instead, prediction sets can be given to a human decision maker as a form of model assistance. The usefulness of prediction sets is correlated to set size-humans have higher accuracy on tasks when given smaller prediction sets. Average set sizes typically vary across groups when the underlying model has some accuracy disparity across the groups. As a result, human accuracy will improve more for groups which have smaller sets on average, causing Disparate Impact.

Uncertainty Quantification with Equalized Coverage can make this unfairness worse. If a group in the data is under-covered using marginal CP, equalizing its coverage requires increasing set sizes, harming downstream accuracy even more. Substantive fairness-achieving comparable accuracy across groups—may thus be better served by equalizing set sizes.

Privacy Can Affect Robustness: Models trained with DPSGD (Equation 3) tend to be less adversarially robust than the same models trained without DP guarantees. The clipping and noise addition steps in DPSGD slow the convergence of models, resulting in decision boundaries that are less smooth which has a strong impact on adversarial robustness.

Robustness Can Affect Privacy: Adversarial training (Equation. 5), designed to improve adversarial robustness, can increase the influence of individual data points on the model. This in turn can make the model more susceptible to MIAs. As one example, testing of six common adversarial defense methods found all six increased the success rates of MIAs compared to the same model trained without any specific defense.

Incorporating DP alongside adversarial defenses to protect against MIAs is also non-trivial, as the methodologies conflict in practice. Adversarial training creates several augmentations x^{†} of data points x and typically backpropagates gradients over them in a batch. By comparison, DPSGD computes per-sample gradients, which is on its own computationally inefficient. Incorporating augmented data points would drastically increase the time and memory costs of training and require careful accounting of how much privacy budget is consumed by the use of augmented versions of the data points.

Privacy Can Affect Explainability: DPSGD is designed to obscure the details of any single element of the training data set, but its addition of noise to gradient updates can degrade the fidelity of post hoc explanations by clouding the true relationships between input and output variables. Explanation fidelity across many model architectures and data domains can degrade when DPSGD is used.

Applying DPSGD during training protects elements of the training data set, but not inference data xₜₑₛₜ whose predictions need to be explained. DP can be applied to the explanation mechanism to protect xₜₑₛₜ (Patel et al., 2022), but since DP requires randomization, explanations will necessarily differ each time they are generated for the same xₜₑₛₜ. Unstable and potentially inconsistent explanations undermine understanding of the reasons behind model predictions.

Explainability Can Affect Privacy: Local explanations E_{θ}(x) are supplemental to the model's outputs F_{θ}(x), and as such, pose an additional avenue for private information about data points or the training set to leak from the model. Explanations are designed to reveal details about how specific inputs influence model predictions but can also be exploited to make MIAs more effective. For instance, the explanations generated by LIME consist of a simple model that locally approximates F_{θ}(x) around x. The behavior of these local models will vary depending on whether x was included in the training data set and attackers can exploit these differences in their MIAs.

Privacy Can Affect Uncertainty Quantification: Conformal Prediction could be applied to any model trained with DPSGD without affecting the privacy of the training date, because CP is a post-processing step on the computer model f_{θ}(x). However, CP requires an additional calibration data set which would not inherit any privacy guarantee and hence could be vulnerable to privacy attacks. To mitigate the risk to the calibration data set, private prediction sets can be generated via a DP quantile routine. However, the noise added for DP degrades the coverage for conformal prediction, requiring larger prediction sets to retain the same coverage 1−α, hence overestimating the true model uncertainty.

Even without protecting the privacy of the calibration data, the quality of uncertainty quantification with a differentially private model will suffer compared to a non-private model. The per-example clipping used in DPSGD causes miscalibration, which affects the utility of CP, again by increasing the size of prediction sets.

Uncertainty Quantification Can Affect Privacy: Uncertainty quantification techniques by design provide additional information to supplement the model's prediction, which broadens the attack surface. For example, MIAs targeting prediction sets have shown that an attacker who receives prediction sets has a higher rate of successfully identifying data points that were used in the training data.

Robustness Can Affect Explainability: Adversarial training to enhance robustness can fundamentally alter the representations that are learned by a model. In image classification, features learned with adversarial training are often more interpretable to humans, but other data modalities do not share the same alignment between robust features and human-perceptible patterns. In such domains, adversarial training can lead to unexplainable behaviors and reduced explanation fidelity.

Explainability Can Affect Robustness: Post hoc explanations are susceptible to adversarial perturbations which do not change the model's prediction F_{θ}(x), but greatly change the explanation from explainability interpretations. Users may expect there to be a single interpretable explanation for any given prediction, and hence the possibility of non-robust explanations casts doubt on the veracity of all explanations. Alternatively, adversarial examples can be used to generate explanations from methods like LIME which are not faithful to the model's actual behavior.

Robustness Can Affect Uncertainty Quantification: Conformal prediction sets may fail to be robust if the underlying model is non-robust. Standard CP methods use Softmax scores to compute the conformal scores, so if the class scores of the model applied to the modified test data points

$${f}_{θ} ( {x}_{test}^{†} )$$

vary wildly, so will the conformal evaluation of the modified data point x^{†}. Hence, adversarial training on the underlying model may appear to be a natural defense for CP. However, adversarial training increases the overall uncertainty of models, leading to larger conformal set sizes even for clean data points.

Uncertainty Quantification Can Affect Robustness: CP techniques can be susceptible to adversarial attacks because they introduce additional assumptions on the test data which can be violated by an attacker. The coverage guarantee of conformal prediction relies on exchangeability of the inference with the calibration data, but adversarial perturbations can imperceptibly force test data out-of-distribution. Prediction sets under attack will overestimate the certainty of predictions and often fail to cover the true label. Alternatively, the test data can be perturbed such that coverage is maintained, but prediction set sizes are greatly increased, which reduces the utility of those sets.

Explainability Can Affect Uncertainty Quantification: When generating explanations of a model's predictions, not only should the uncertainty be quantified, but also the uncertainty in the explanation itself. Explanations help users determine when to rely on predictions, investigate potential issues, and confirm that predictions are not influenced by biases. However, high uncertainty about the validity of explanations can erode trust. The feature importances E_{θ}(x) generated by LIME strongly depend on the random noise introduced when constructing the sparse linear model around x, and on the number of perturbed samples used. These factors can lead to significant variations in the rank order of important features, indicating a considerable degree of uncertainty in LIME's explanations that is often overlooked.

Uncertainty Quantification Can Affect Explainability: To help practitioners understand the limitations of a model, explanations should be given as to why it is more uncertain on some inputs than others. When used with CP, explanations must extend to prediction sets C_{q}(x). However, the task of explaining why the model has predicted the entire set is inherently more difficult than explaining the top prediction F_{θ}(x), especially when some elements of the set may be contradictory or incompatible with others.

Combining Multiple Modifications Even among only the aspects more significantly discussed above, there are many interactions between them such that when implementing modifications for one aspect, it may yield negative effects for another, such that the combination of multiple such modifications may have undesired or unexpected effects. As such, though it may be desirable to account for multiple TAI aspects for a particular model, the associated modifications may not be applied together with reliable results that provide overall benefit to all of the aspects. In addition, accounting for the modifications and their interactions may not be possible before implementing the modifications. To provide improvements to multiple TAI aspects, the relative priority of the TAI aspects is used to order the sequence in which modifications are applied. As a modification is applied, the effect on metrics for relevant TAI aspects is determined to determine whether higher-priority TAI aspects are unduly affected by applied modification.

### Optimizing Combination of TAI Modifications

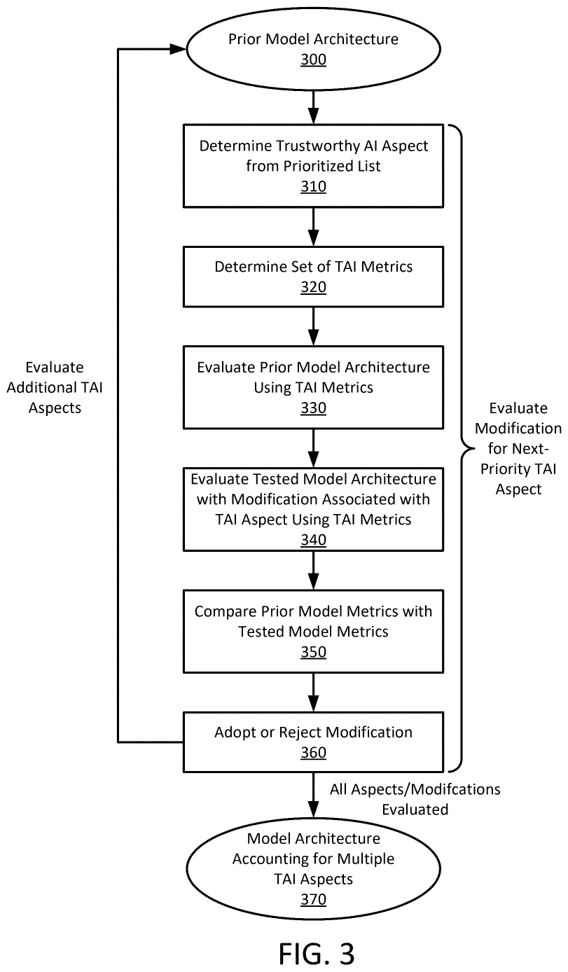

FIGS. 2A-C show example data flows of modifications for TAI aspects, according to one or more embodiments. As discussed above, the various TAI aspects may affect one another in expected and unexpected ways. To account for these interactions while enabling automatic exploration of the relevant TAI aspects for improving a model deployment, the modifications associated with various aspects may be sequentially evaluated for inclusion in the model architecture according to the priority of the TAI aspects and the effects of the modification of each TAI aspect on other TAI aspects. In various embodiments, the data flows shown in FIGS. 2A-C and method discussed below with respect to FIG. 3 may be coordinated by a model modification module 120 as discussed above.

Initially, the model architecture to be evaluated for inclusion of additional TAI aspects is identified along with an aspect ranking 200 of a variety of TAI aspects 210. FIG. 2A shows an initial step for incorporating TAI aspects 210, such that a prior model architecture 230A represents an initial model architecture without incorporating modifications related to the various TAI aspects 210. That is, the prior model architecture 230A may represent a model architecture designed for a particular objective but may not include architectural components related to the TAI aspects 210. The prior model architecture 230A may thus include a configuration for developing, training and/or deploying the model with respect to the objective. The particular details may vary according to the particular data type, model architecture, and goal of the model. For example, a model architecture for image classification may include a model architecture for training parameters of the model with an objective to most-accurately predict an output class based on a set of image training data.

As an overview, at each “iteration,” a modification 215 is selected for evaluation based on the aspect ranking 200. The selected modification 215 is included in the model architecture to yield a tested model architecture 240 for that iteration. Each model architecture is then assessed with metrics of interest and used to evaluate the effect of the selected modification on the TAI aspects of interest and determine whether to adopt (accept) or reject the modification for subsequent evaluations.

The aspect ranking 200 includes a ranking or other prioritization of a set of TAI aspects 210. In the example of FIG. 2A-C, the aspect ranking 200 includes three aspects 210A-C. Each aspect 210A-C is associated with a modification 215A-C and a metric 220A-C. Though one modification 215 and one metric 220 are shown in FIGS. 2A-C, in various embodiments, each TAI aspect 210 may be associated with more than one modification 215 or metric 220. Each modification 215 is a change that may be made to the model architecture that is expected to improve the one or more metrics 220 for the associated TAI aspect 210. As discussed above, various TAI aspects may be associated with different types of modifications that may affect different parts of the model architecture. For example, one modification 215 for privacy includes a modification to the training process to use differential-privacy stochastic gradient descent, while another modification 215 associated with fairness includes modifying conformal score calibration, a post-training calibration on the model data. Similarly, the metrics may need to be measured at different points in the model development and deployment process; one metric 220 related to privacy may measure data leakage according to a differential privacy framework, while another metric 220 related to fairness may measure differences in model accuracy or conformal set size across groups.

The aspect ranking 200 describes the relative prioritization of the various TAI aspects 210A-C and may be used to determine a sequence in which modifications are evaluated for inclusion to the model architecture, along with the prioritization of respective metrics. For example, even if a modification 215 improves the metric for given aspect 210 improves a metric 220 for that aspect 210, that modification may still be rejected if it excessively affects another metric 220 for an aspect 210 having a higher priority in the aspect ranking 200. The aspect ranking 200 may be specified by a data scientist, modeling engineer, or various stakeholders in to determine the relative importance of the aspects 210 for this particular model implementation. The aspect ranking 200 may thus vary in different embodiments and for different models. FIGS. 2A-2C show a working example of the interactions between the modifications and metric evaluations in various embodiments.

In the example of FIG. 2A, the prior model architecture 230A does not include any modifications 215A-C related to TAI aspects 210A-C. To effectively address the aspects in order of the respective priorities, the aspect ranking 200 is used to select a modification 215 associated with the highest-priority aspect 210 that has not yet been evaluated. In FIG. 2A, the aspects 210A-C are listed in their priority rank order, such that aspect 210A is the highest-priority aspect and aspect 210C is the lowest-priority aspect. Since no TAI aspects 210A-C have been evaluated, the highest-priority aspect 210A and its associated modification 215A is selected for evaluation. Because this is the initial TAI aspect to be included for the model, the prior model architecture 230A may include no current modifications for TAI aspects. A tested model architecture 240A is determined that includes the selected modification 215A applied to the prior model architecture 230A. As such, the tested model architecture 240A includes modification 215A as an active modification to be tested for adoption to the model.

Next, one or more metrics 220 associated with the TAI aspects 210 are evaluated with respect to the prior model architecture 230 and the tested model architecture 240. A set of metrics to evaluate may be selected from the set of metrics 220 associated with aspects 210 of interest. In some embodiments, all metrics 220 associated with the aspects may be included for evaluation. In additional embodiments, only metrics associated with the selected aspect for the current modification (here, modification 215A) and metrics associated with higher-priority metrics are included for evaluation. The selected metrics are then used to evaluate the prior model architecture 230A to determine a set of prior model metrics 250A. Similarly, the selected metrics are used to evaluate the tested model architecture 240A that includes the selected modification 215A to determine a set of tested model metrics 260A. In the embodiments of FIGS. 2A-2C, the selected metrics include the metrics 220 for the selected aspect 210 along with metrics 220 for aspects 210 having a higher-priority in the aspect ranking 200. Specifically, in FIG. 2A, the aspect 210A is selected, such that the evaluated metrics include metric 220A. In further embodiments, additional metrics may also be included in the evaluation, such as metrics for aspects unrelated to TAI, such as a metric related to model accuracy or the overall model objective.

Evaluation of the relevant metrics on the prior model architecture 230 and the tested model architecture 240 differs according to the particular model architecture, relevant modification, and relevant metrics. That is, the particular metrics to be measured and the modifications may have various forms as discussed above and may include modifications to and measurements related to training data, pre-processing, model layers, training processes and training objectives, post-training validation, inference processes, and so forth. In some embodiments, the respective model architectures are trained (or retrained) with the respective active modifications and the metrics are evaluated during the model training processes.

After determining a set of prior model metrics 250A and tested model metrics 260A, the respective metrics are compared 270A to determine whether to adopt the selected modification 215. In the example of FIG. 2A, the tested model metrics 260A improve the metrics for the evaluated TAI aspect 210A relative to the prior model metrics 250A, so the modification 215A is adopted to the model architecture. Additional details for evaluating the compared metrics and determining whether to adopt or reject the modification are discussed below with respect to FIG. 3.

Next, as shown in FIG. 2B, the modification associated with the next-highest priority aspect in the aspect ranking 200 is evaluated for inclusion. Because modification 215A was adopted, the prior model architecture 230B now includes modification 215A. As such, as subsequent aspects 210 are evaluated in the aspect ranking 200, modifications adopted for prior-evaluated modifications (i.e., related to high-priority aspects) may be included in evaluating a modification 215B for the current aspect 210B.

In the example of FIG. 2B, the next priority aspect in the aspect ranking 200 is aspect 210B having corresponding modification 215B. The modification 215B is then included in the tested model architecture 240B along with the other modifications that were previously adopted according to prior model architecture evaluations. In this instance, the tested model architecture 240B thus adds modification 215B to the adopted modification 215B for the tested model architecture 240B. As discussed in FIG. 2A, a set of model metrics is selected and applied to the evaluated the prior model architecture 230B and the tested model architecture 240B. The model metrics evaluated may include metrics associated with the evaluated TAI aspect 210B in addition to other TAI aspects 210 in the aspect ranking 200, and in some embodiments may include metrics for aspects 210 having a higher-priority than the evaluated aspect. In this example, metrics 220A and 220B are evaluated for the model architectures. By evaluating these model architectures, the inclusion of modification 215B and its effects on the model metrics can be determined when modification 215B is considered in addition to modifications for other TAI aspects. In addition, the metrics measure not only the effect of the modification 215B on the aspect associated with the modification (i.e., aspect 210B), it also measures the effect of the modification 215B on higher-priority aspects. As a result, the incremental effect of the modification 215B can be assessed in consideration with its effects on other TAI aspects and allows measurement of the interrelated effects of modifications on one another.

In the example of FIG. 2B, when the metrics are compared 270B between the prior model metrics 250B and tested model metrics 260B, the comparison of the metrics reveals an effect on the TAI metrics that is outside an acceptable threshold and the modification 215B is rejected. This may happen, for example, because although modification 215B may improve associated metric 220B for aspect 210B, the modification 215B, when combined with modification 215A (already adopted) in tested model architecture 240B, negatively affects metric 220A. The metric 220A is associated with higher-priority aspect 210A in the aspect ranking 200, so the modification 215B for a comparatively lower-priority aspect 210B is not adopted.

Evaluation of the third modification 215C continues as shown in FIG. 2C. Because the modification 215B was not accepted, the prior model architecture 230C may continue to include modification 215A but does not include modification 215B. As discussed, the next-highest priority aspect 210C is selected for evaluating its associated modification 215C. Accordingly, the tested model architecture 240C includes the previously adopted modification 215A along with modification 215C. Similarly, the metrics 220 evaluated for the prior model architecture 230C and tested model architecture 240C may include metric 220C for the evaluated aspect 210C along with metrics 220 for additional aspects 210, and particularly may include metrics 220A-B for the higher-priority aspects 210A-B. As before, the prior model architecture 230C is evaluated with the selected metrics to determine prior model metrics 250C, and tested model architecture 240C is evaluated with the selected metrics to determine tested model metrics 260C.

Notably, although the modification 215B was not adopted in the model architecture, the associated aspect 210B is still a higher priority than aspect 210C in the aspect ranking 200. Accordingly, the metric 220B is included when evaluating modification 215C. As such, even though no modification specifically improving aspect 210B was included, the associated metric 220B for aspect 210B may still be included for evaluating lower-priority aspects to ensure that evaluated modifications for further aspects 210 do not unduly and negatively impact higher-priority aspects 210. In the example of FIG. 2C, the comparison 270C of the prior model metrics 250C and tested model metric 260C indicates that the addition of modification 215C does not impact the evaluated metrics beyond an acceptable threshold, such that the modification 215C is adopted for the model architecture. By evaluating aspects in priority order and considering the incremental effect of modifications with consideration of other modifications and metrics for higher-priority aspects, this approach can apply modifications to account for TAI aspects and their interrelated affects in a principled way that captures the “intersectional” effects of how accounting for multiple AI aspects can unexpectedly affect one another.

FIG. 3 shows an example flow chart for incorporating multiple TAI aspects to a model, according to one or more embodiments. Particularly, modifications related to various TAI aspects are evaluated and may be incorporated according to the prioritization of the TAI aspects for the model. As discussed above, the modifications may be evaluated in a priority order for the relevant TAI aspects, such that the modifications may be iteratively added after considering the effects of the modification on other TAI aspects.

For each TAI aspect to be evaluated, there is a prior model architecture 300 that represents the condition of the model architecture before evaluating the current TAI aspect. For the initial TAI aspect, the prior model architecture 300 may include the model architecture that does not include consideration of TAI aspects (e.g., a baseline or “standard” architecture for optimizing an objective function for accuracy with respect to the model objective). At each iteration to evaluate TAI aspects, the subsequent trustworthy AI (TAI) aspect to evaluate is determined 310 from the list of prioritized TAI aspects. That is, the list of TAI aspects provides a prioritization of the TAI aspects that provides a sequence for evaluating metrics and incorporating modifications for TAI aspects. As each TAI aspect in the sequence is evaluated, the modifications for the relevant TAI aspect is evaluated with respect to the “state” of the architecture before considering that TAI aspect. As such, a modification to the model architecture for each TAI aspect is considered in in conjunction with any previously-accepted modifications for other, higher-priority TAI aspects. Each TAI aspect may thus have some aspects that are higher priority and others that are lower priority on the prioritized list.

At each iteration, a trustworthy AI aspect (TAI) is determined 310 for evaluation from the prioritized list. Typically, the TAI aspect is the highest-priority TAI aspect that has not yet been evaluated for the model architecture, such that the prioritized list provides the sequence in which TAI aspects are evaluated (i.e., the associated modifications). The determined TAI aspect is associated with a modification to be evaluated in the current iteration.

Next, the set of metrics is determined 320 that will be used for evaluating the model architecture with and without the modification associated with the determined 310 trustworthy AI aspect. The set of metrics may include all metrics for the TAI aspects in the prioritized list of TAI aspects, and in some embodiments may also include one or more metrics evaluating model quality (i.e., model accuracy, recall, precision, and so forth). In some embodiments, the set of metrics include metrics for TAI aspects that are higher priority than the currently-evaluated TAI aspect (e.g., the aspect determined 310 from the list). In some embodiments, the set of metrics excludes metrics for TAI aspects that are lower priority than the currently-evaluated TAI aspect. In the example of FIG. 2B, for example, when evaluating the aspect 210B, metrics 220A-B for aspects 210A-B may be included, while the metric 220C for aspect 210C is excluded because aspect 210C has a lower priority than the aspect 210B. As a result, each modification may be considered in view of the relevant metrics for the TAI aspects that are, relatively, more important to model development.

Next, the prior model architecture is evaluated 330 using the determined 320 set of metrics to determine prior model metrics describing performance of the prior model architecture on the relevant metrics. Similarly, the tested model architecture, which includes the additional modification of the evaluated TAI metric, is evaluated 340 using the determined 320 set of metrics to determine tested model metrics describing performance of the tested model architecture. As discussed above, the particular metrics and steps for performing model evaluation may vary based on the model architectures, modifications, metrics, and so forth. Evaluating the model architectures may include modifying training data (e.g., splitting training data to training, validation, and test sets), modifying training processes or objectives, modifying validation and inference processes, and so forth.

The metrics from the respective model architectures are then compared 350 with one another to determine the effect of the modification when added to the prior model architecture 300. Particularly, the prior model metrics are compared 350 with the tested model metrics to determine the incremental effect of the modification on the determined 320 set of TAI metrics. This comparison demonstrates the effect that the modification has on various aspects when combined with the other modifications of the prior model architecture 300. Because the prior model architecture 300 may include modifications for other TAI aspects, this enables the modification to be evaluated in context for the specific model under consideration and with respect to how multiple such modifications may affect one another.

Based on the comparison, the modification is adopted (accepted) or rejected 360 for use with the model. When the modification is adopted, it may be added to the prior model architecture 300 when evaluating additional TAI aspects from the prioritized list. The determination of whether to adopt or reject the modification being evaluated (e.g., at the current iteration) varies in different embodiments and may vary with respect to different metrics. The particular considerations for accepting the modification may also be specified in association with the prioritized list of TAI aspects, such that each aspect may be associated with a threshold or other evaluation criteria for determining when metrics for that TAI aspect are excessively impacted by a modification. In particular, the comparison of metrics for TAI aspects that are a higher-priority (i.e., earlier in the prioritized list) than the determined 310 TAI aspect may be particularly relevant for adopting or rejecting a modification. For example, in the example of FIG. 2B, the modification 215B associated with the second aspect 210B, was rejected because it excessively affected the metric 220A associated with the higher-priority aspect 210A.

In addition to the metrics for TAI aspects, the metrics may also include consideration for the impact of the modifications on model quality, such that the extent to which a modification may affect the model quality is also captured by the metrics and can be meaningfully assessed at each iteration as additional TAI aspect modifications are evaluated.

The determination for adopting or rejecting the modification may be based on the extent to which each metric is affected at a given iteration or may be based on an accumulated metric change across multiple iterations or a combination of these. For example, a metric related to privacy may measure the extent to which private data can be derived from information released by the model. This privacy metric may have a certain threshold for individual modifications (e.g., each incremental modification cannot reveal more than a first threshold) and another threshold across the combination of applied modifications (e.g., an accumulation of privacy loss across multiple modifications cannot reveal more than a second threshold). By monitoring the extent to which each modification affects the metrics of interest, the modifications may be adopted or rejected at each iteration with a principled and numerically-driven evaluation of the ways in which different TAI aspects affect one another in practice.

After a particular TAI aspect is evaluated, the model architecture adopts or rejects the modification for that TAI aspect as the prior model architecture 300 for the next-priority TAI aspect to be evaluated. The next iteration then evaluates a modification for the next TAI aspect, which may be continued until all TAI aspects are evaluated according to this process. After evaluating all aspects, a number of the modifications may be adopted that do not excessively affect one another, providing a model architecture 370 that accounts for multiple TAI aspects. Because modifying model architectures may be highly expensive computationally, this approach enables a principled exploration of the possible modifications to be included for a model architecture that reduces computational and other resource requirements as each modification is evaluated when the respective TAI aspect is next on the priority list. Because the TAI aspects are in priority order, it also ensures that the most important TAI aspects for the particular model are evaluated first and those modifications are most likely to be accepted, such that additional TAI aspects are included when they do not excessively affect the higher-priority aspects.

In summary, this approach enables all relevant stakeholders to enumerate and prioritize the TAI aspects relevant to a particular model and automatically determine the model architecture for incorporating them without excess processing that would be required for assessing combinations of modifications in other ways. This approach thus provides a way to automatically evaluate and test relevant aspects and demonstrate how modifications intended to improve one TAI aspect affects another, while layering and including modifications for TAI aspects when possible based on measured interactions between them.

Because a model's utility remains theoretical until it is deployed, these considerations are essential for providing adherence to laws and regulations on fairness, data privacy, and more. Without effectively considering these effects that modifications for one TAI aspect may have on another, even the most accurate models may never reach real-world application. Although in some cases TAI aspects may inherently be in some tension with one another, by evaluating and adopting TAI aspects in a prioritized sequence, that tension can be captured and expressly evaluated, allowing multiple TAI aspects to be included in the final model architecture.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system for model development with aspects of trustworthy AI, comprising:
a processor that executes instructions; and
a non-transitory computer-readable medium having instructions executable by the processor for:
determining a trustworthy AI (“TAI”) aspect from a prioritized list of TAI aspects that has an associated modification for improving the TAI aspect;
evaluating a prior model architecture that does not have the associated modification according to a set of TAI metrics to determine a set of prior model metrics;
evaluating a tested model architecture that includes the associated modification according to the set of TAI metrics to determine a set of tested model metrics;
comparing the set of prior model metrics and the set of tested model metrics; and
based on the comparison, accepting or rejecting the modification.

2. The system of claim 1, wherein the instructions are further executable for:
after accepting the modification, evaluating a subsequent TAI aspect having a lower priority on the prioritized list of TAI aspects with a subsequent prior model architecture including the accepted modification.

3. The system of claim 1, further comprising determining the set of TAI metrics based on the prioritized list of TAI aspects.

4. The system of claim 1, wherein the TAI metrics include metrics associated with one or more additional TAI aspects having a higher priority than the TAI aspect on the prioritized list of TAI aspects.

5. The system of claim 1, wherein the TAI metrics exclude metrics associated with one or more additional TAI aspects having a lower priority than the TAI aspect on the prioritized list of TAI aspects.

6. The system of claim 1, wherein the modification is accepted when comparison of one or more TAI metrics associated with one or more higher-priority TAI aspects on the prioritized list of TAI aspects is within a threshold.

7. The system of claim 1, wherein the prior model architecture and the tested model architecture implement a large language model or an agentic task processing model.

8. A method for model development with aspects of trustworthy AI, comprising:
determining a trustworthy AI (“TAI”) aspect from a prioritized list of TAI aspects that has an associated modification for improving the TAI aspect;
evaluating a prior model architecture that does not have the associated modification according to a set of TAI metrics to determine a set of prior model metrics;
evaluating a tested model architecture that includes the associated modification according to the set of TAI metrics to determine a set of tested model metrics;
comparing the set of prior model metrics and the set of tested model metrics; and
based on the comparison, accepting or rejecting the modification.

9. The method of claim 8, wherein the method further comprises:
after accepting the modification, evaluating a subsequent TAI aspect having a lower priority on the prioritized list of TAI aspects with a subsequent prior model architecture including the accepted modification.

10. The method of claim 8, further comprising determining the set of TAI metrics based on the prioritized list of TAI aspects.

11. The method of claim 8, wherein the TAI metrics include metrics associated with one or more additional TAI aspects having a higher priority than the TAI aspect on the prioritized list of TAI aspects.

12. The method of claim 8, wherein the TAI metrics exclude metrics associated with one or more additional TAI aspects having a lower priority than the TAI aspect on the prioritized list of TAI aspects.

13. The method of claim 8, wherein the modification is accepted when comparison of one or more TAI metrics associated with one or more higher-priority TAI aspects on the prioritized list of TAI aspects is within a threshold.

14. The method of claim 8, herein the prior model architecture and the tested model architecture implement a large language model or an agentic task processing model.

15. A non-transitory computer-readable medium for model development with aspects of trustworthy AI, the non-transitory computer-readable medium comprising instructions executable by a processor for:
determining a trustworthy AI (“TAI”) aspect from a prioritized list of TAI aspects that has an associated modification for improving the TAI aspect;
evaluating a prior model architecture that does not have the associated modification according to a set of TAI metrics to determine a set of prior model metrics;
evaluating a tested model architecture that includes the associated modification according to the set of TAI metrics to determine a set of tested model metrics;
comparing the set of prior model metrics and the set of tested model metrics; and
based on the comparison, accepting or rejecting the modification.

16. The non-transitory computer-readable medium of claim 15, the instructions being further executable for:
after accepting the modification, evaluating a subsequent TAI aspect having a lower priority on the prioritized list of TAI aspects with a subsequent prior model architecture including the accepted modification.

17. The non-transitory computer-readable medium of claim 15, wherein the instructions are further executable for determining the set of TAI metrics based on the prioritized list of TAI aspects.

18. The non-transitory computer-readable medium of claim 15, wherein the TAI metrics include metrics associated with one or more additional TAI aspects having a higher priority than the TAI aspect on the prioritized list of TAI aspects.

19. The non-transitory computer-readable medium of claim 15, wherein the TAI metrics exclude metrics associated with one or more additional TAI aspects having a lower priority than the TAI aspect on the prioritized list of TAI aspects.

20. The non-transitory computer-readable medium of claim 15, wherein the modification is accepted when comparison of one or more TAI metrics associated with one or more higher-priority TAI aspects on the prioritized list of TAI aspects is within a threshold.
